(19) United States
(12) Patent Application Publication
(10) Pub. No.: US 2023/0320424 A1
(43) Pub. Date: Oct. 12, 2023

(54) AEROSOL GENERATION DEVICE AND INFRARED HEATER

(71) Applicant: SHENZHEN FIRST UNION TECHNOLOGY CO., LTD., Shenzhen City, Guangdong Province (CN)

(72) Inventors: ZUQIANG QI, Shenzhen City, Guangdong Province (CN); JIAMAO LUO, Shenzhen City, Guangdong Province (CN); BAOLING LEI, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/028,207

(22) PCT Filed: Sep. 23, 2021
(86) PCT No.: PCT/CN2021/119923

§ 371 Date: Mar. 23, 2023

(30) Foreign Application Priority Data
Sep. 23, 2020 (CN) 202011006475.3

(51) Int. Cl. A24F 40/46; A24F 40/70

(52) U.S. Cl. CPC A24F 40/46; A24F 40/70

(57) ABSTRACT

An aerosol generation device and an infrared heater are provided. The aerosol generation device includes a chamber configured to receive an aerosol forming substrate, at least one infrared heater, and a battery cell providing power to the infrared heater, where the infrared heater includes: a carbon material heating film, configured to radiate infrared to the chamber, to heat the aerosol forming substrate received in the chamber; a support member, configured to support the carbon material heating film; a conductive element, configured to provide the power to the carbon material heating film; and an anti-oxidization layer, formed on at least a part of a surface of the carbon material heating film and covering a part of the conductive element. The anti-oxidization layer covers the carbon material heating film and a part of the conductive element to avoid problem that it is easy for an oxidization reaction to occur in carbon material.

### CROSS-REFERENCE TO RELATED APPLICATIONS

This application claims priority to Chinese Patent Application No. 202011006475.3, filed with the China National Intellectual Property Administration on Sep. 23, 2020 and entitled “AEROSOL GENERATION DEVICE AND INFRARED HEATER”, which is incorporated herein by reference in its entirety.

### TECHNICAL FIELD

Embodiments of this application relate to the field of cigarette device technologies, and in particular, to an aerosol generation device and an infrared heater.

### BACKGROUND

During use of smoking objects such as a cigarette or cigar, tobaccos are burnt to generate vapor. A product that releases compounds without burning has been tried to provide an alternative for the objects that burn tobaccos. An example of the products is a heat-not-burn product, which releases compounds by heating tobaccos rather than burning tobaccos.

The patent publication No. CN109105957A discloses a heating device for e-cigarettes and low temperature heating cigarettes. Materials for preparing the heating device include one or more of carbon nanotubes, carbon nanotube films, graphene, carbon fibers, carbon fiber films, carbon films, and carbon fiber cloth. After being electrified, the foregoing electric heating materials heat a substance that can generate odor and/or nicotine and/or vapor-gas after being heated or burned.

A problem existing in the cigarette device is as follows: It is easy for an oxidization reaction to occur in a carbon material in an oxidizing atmosphere at a high temperature. Consequently, physical and mechanical properties of the carbon material quickly deteriorate, to limit high-temperature use characteristics of the carbon material.

### SUMMARY

This application provides an aerosol generation device and an infrared heater, aiming to resolve the problem that it is easy for an oxidization reaction to occur in a carbon material in an existing cigarette device.

An aspect of this application provides an aerosol generation device, including a chamber configured to receive an aerosol forming substrate, at least one infrared heater, and a battery cell providing power to the infrared heater, where
the infrared heater includes:
a carbon material heating film, configured to radiate infrared to the chamber, to heat the aerosol forming substrate received in the chamber;
a support member, configured to support the carbon material heating film;
a conductive element, configured to provide the power to the carbon material heating film; and
an anti-oxidization layer, formed on at least a part of a surface of the carbon material heating film and covering a part of the conductive element.

Another aspect of this application provides an infrared heater for an aerosol generation device, the aerosol generation device including a chamber configured to receive an aerosol forming substrate and a battery cell providing power to the infrared heater, where the infrared heater includes:
a carbon material heating film, configured to radiate infrared to the chamber, to heat the aerosol forming substrate received in the chamber;
a support member, configured to support the carbon material heating film;
a conductive element, configured to provide the power to the carbon material heating film; and
an anti-oxidization layer, formed on at least a part of a surface of the carbon material heating film and covering a part of the conductive element.

In the aerosol generation device and the infrared heater provided in this application, the anti-oxidization layer covers the carbon material heating film and a part of the conductive element, to avoid the problem that it is easy for an oxidization reaction to occur in the carbon material, thereby improving stability and reliability of the carbon material heating film. Additionally, it is convenient to couple a part of the conductive element not covered by the anti-oxidization layer to the battery cell, thereby improving efficiency of assembling the cigarette device.

### BRIEF DESCRIPTION OF THE DRAWINGS

One or more embodiments are described by way of example with reference to the corresponding figures in the accompanying drawings, and the exemplary descriptions are not to be construed as limiting the embodiments. Elements/modules and steps in the accompanying drawings that have same reference numerals are represented as similar elements/modules and steps, and unless otherwise particularly stated, the figures in the accompanying drawings are not drawn to scale.

FIG. 1 is a schematic diagram of an aerosol generation device according to an implementation of this application;

FIG. 2 is a schematic diagram of an aerosol generation device with a cigarette inserted according to an implementation of this application;

FIG. 3 is a schematic diagram of an infrared heater according to an implementation of this application;

FIG. 4 is a schematic diagram of an infrared heater unfolded according to an implementation of this application; and

FIG. 5 is a schematic diagram of another infrared heater according to an implementation of this application.

### DETAILED DESCRIPTION

For ease of understanding of this application, this application is described below in more detail with reference to accompanying drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as those usually understood by a person skilled in art of this application. Terms used in this specification of this application are merely intended to describe objectives of the specific implementations, and are not intended to limit this application. The term “and/or” used in this specification includes any or all combinations of one or more related listed items.

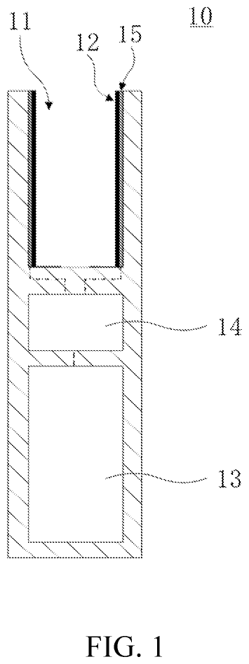

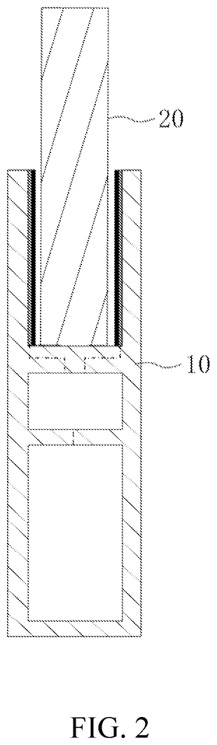

FIG. 1 and FIG. 2 show an aerosol generation device 10 provided in an implementation of this application and including the following:

A chamber 11 is configured to receive an aerosol forming substrate 20, for example, a cigarette.

The aerosol-forming substrate is a substrate that can release a volatile compound that can form an aerosol. The volatile compound can be released by heating the aerosol-forming substrate. The aerosol-forming substrate may be solid, or liquid, or components including solid and liquid. The aerosol-forming substrate may be loaded onto a carrier or support through adsorbing, coating, impregnating, or in other manners. The aerosol-forming substrate may conveniently be a part of the aerosol-forming article.

The aerosol-forming substrate may include nicotine. The aerosol-forming substrate may include tobacco, for example, a tobacco-containing material including a volatile tobacco aroma compound. The volatile tobacco aroma compound is released from the aerosol-forming substrate when heated. Preferably, the aerosol-forming substrate may include a homogeneous tobacco material. The aerosol-forming substrate may include at least one aerosol-forming agent, and the aerosol-forming agent may be any suitable known compound or a mixture of compounds. During use, the compound or the mixture of compounds facilitates condensing and stabilizing formation of the aerosol and is substantially resistant to thermal degradation at an operating temperature of an aerosol-forming system. Suitable aerosol-forming agents are well known in the related art and include, but are not limited to: polyol, such as triethylene glycol, 1, 3-butanediol, and glycerol; ester of polyol, such as glycerol mono-, di- or triacetate; and fatty acid ester of mono-, di- or polycarboxylic acid, such as dimethyl dodecanedioate and dimethyl tetradecanedioate. Preferably, the aerosol forming agent is polyhydric ester or a mixture thereof, such as triethylene glycol, 1,3-butanediol, or most preferably, glycerol.

An infrared heater 12 is constructed to radiate infrared to the chamber 11, to heat the aerosol forming substrate received in the chamber 11.

A battery cell 13 provides power used for operating the aerosol generation device 10. For example, the battery cell 13 may provide power to heat the infrared heater 12. Moreover, the battery cell 13 may provide power required for operating other elements provided in the aerosol generation device 10.

The battery cell 13 may be a rechargeable battery or a disposable battery. The battery cell 13 may be, but is not limited to, a lithium iron phosphate (LiFePO4) battery. For example, the battery cell 13 may be a lithium cobaltate (LiCoO2) battery or a lithium titanate battery.

A circuit 14 may control an overall operation of the aerosol generation device 10. The circuit 14 not only controls operations of the battery cell 13 and the infrared heater 12, but also controls operations of other elements in the aerosol generation device 10. For example, the circuit 14 obtains information about a temperature of the infrared heater 12 sensed by a temperature sensor, and controls, according to the information, power provided by the battery cell 13 to the infrared heater 12.

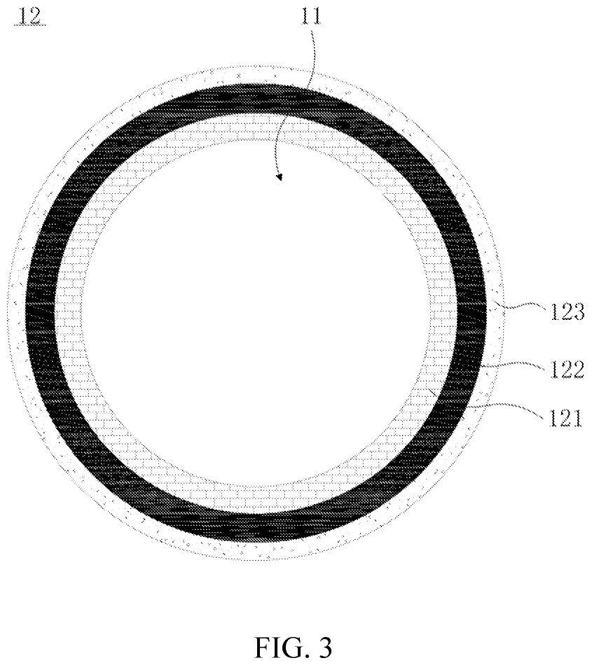

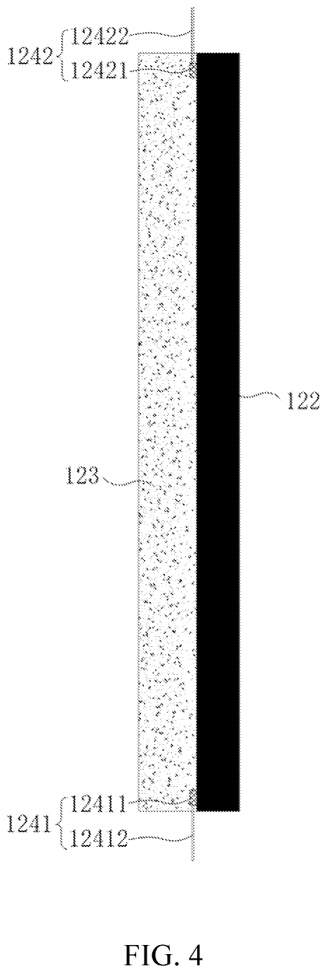

FIG. 3 and FIG. 4 show an infrared heater 12 according to an implementation of this application. The infrared heater 12 includes a support member 121, a carbon material heating film 122, and an anti-oxidization layer 123.

In this example, the support member 121 is constructed as a tube shape extending in an axial direction of a chamber 11 and surrounding the chamber 11. An inner surface of the support member 121 faces the chamber 11, or forms at least one part of the chamber 11. It should be noted that, in another example, the support member 121 may alternatively not be in a tube shape, but be, for example, a prism shape, a plate shape, or a half-cylinder shape.

The support member 121 is made of a high-temperature resistant and transparent material such as quartz glass, ceramic, or mica, and may alternatively be made of another material with a relatively high infrared transmittance, for example, a high-temperature resistant material with an infrared transmittance above 95%.

The carbon material heating film 122 is constructed to extend in an axial direction of the chamber 11 and at least partially surround the chamber 11. That is, the carbon material heating film 122 may be bound to a part of an outer surface of the support member 121, and may alternatively wrap the entire outer surface of the support member 121.

In this example, an inner surface (or a first surface) of the carbon material heating film 122 is bound to the entire outer surface of the support member 121, and then held or supported on the outer surface of the support member 121. It should be noted that, in another example, the carbon material heating film 122 may be bound to the outer surface of the support member 121 in a winding manner; or the carbon material heating film 122 is formed on a flexible substrate, and then wound together with the flexible substrate and bound to the outer surface of the support member 121.

The carbon material heating film 122 may be made of a derivative and a compound having carbon as some or all component elements and including, but not limited to, one or more a carbon nanotube film, a graphene film, a carbon fiber film, a carbon film, and a carbon fiber cloth.

The anti-oxidization layer 123 is formed on at least a part of an outer surface (or a second surface) of the carbon material heating film 122. The arrangement of the anti-oxidization layer 123 can avoid the problem that it is easy for an oxidization reaction to occur in a carbon material. Preferably, the anti-oxidization layer 123 wraps the entire outer surface and radial surfaces of the carbon material heating film 122.

The anti-oxidization layer 123 may be formed on the outer surface of the carbon material heating film 122 in at least one manner of brushing, dip coating, spraying, physical vapor deposition, and chemical vapor deposition. The anti-oxidization layer 123 has a thickness ranging from 1 to 50 μm, preferably 1 to 40 μm, further preferably 1 to 30 μm, further preferably 2 to 30 μm, and further more preferably 3 to 30 μm.

Processes of forming the anti-oxidization layer 123 are described below in the dip coating manner and the spraying manner:

### Embodiment 1

The anti-oxidization layer 123 is formed on the outer surface of the carbon material heating film 122 in the dip coating manner, which specifically includes:

Step 11: Immerse the carbon material heating film 122 in a low-temperature glaze liquid. The low-temperature glaze liquid may be an aqueous solution containing an oxide such as silicon dioxide, aluminum oxide, magnesium oxide, calcium oxide, zinc oxide, titanium dioxide, tin oxide, lanthanum oxide, or bismuth oxide. Before immersion, the low-temperature glaze liquid passes through a curing machine or a high-energy ball milling shaker, so that particles in the solution are evenly dispersed in the solution. The immersion time is 10 seconds to 1 minute.

Step 12: Take the carbon material heating film 122 out from the low-temperature glaze liquid, and dry in the air until being in a state that no liquid drop falls.

Step 13: Place the carbon material heating film 122 into a heat treatment furnace protected by argon. Preferably, a vacuum heat treatment furnace may be used, and a background vacuum degree is 1.0×10\hat{ }(−3) Pa. After argon is fed to perform heating, the vacuum degree is 1.0×10\hat{ }(−1) Pa to 10 Pa, and preferably, the vacuum degree is about 1 Pa. The argon flow is 100 sccm, and the heat treatment temperature is 750° C. to 1150° C., and preferably 850° C. The heat treatment time is 4 to 24 hours, and preferably 8 hours.

After heat treatment, the glaze is cured on a surface of the carbon material heating film 122, and forms the condensed anti-oxidization layer 123, to avoid a case that the carbon material heating film 122 comes into direct contact with oxygen gas in the air during use and is oxidized and deteriorated.

### Embodiment 2

The anti-oxidization layer 123 is formed on the outer surface of the carbon material heating film 122 in the spraying manner, which specifically includes:

Step 21: Prepare a spraying solution.

The spraying solution may include nanoscale ceramic powder, a dispersing agent, a defoaming agent, and a bonding agent. The nanoscale ceramic powder may include one or more types of ceramic powder such as silicon oxide, aluminum oxide, zirconium oxide, zinc oxide, titanium oxide, cerium oxide, and lanthanum oxide, and the particle size of the ceramic powder is controlled to be 10 to 100 nm in a manner such as ball milling pulverization or filtering. The dispersing agent is used for keeping nano-particles stable and preventing agglomeration, and may include one or more of polyethylene glycol, sodium polyacrylate, and ammonium polyacrylate. The defoaming agent prevents a coating from being foamed during stirring or spraying, and may be ethanol. The bonding agent may be polyvinyl alcohol. The nanoscale ceramic powder, the dispersing agent, the defoaming agent, and the bonding agent are mixed and stirred evenly, to obtain the spraying solution.

Step 22: Spray the spraying solution evenly on the surface of the carbon material heating film 122 with an ultrasonic spraying equipment.

Step 23: Cure the spraying solution on the surface of the carbon material heating film 122 under a condition of 80° C. to 300° C. A vast majority of materials of the dispersing agent, the defoaming agent, and the bonding agent are volatilized during curing, and only the condensed ceramic coating, that is, the anti-oxidization layer 123 remains.

In terms of the microcosmic structure, in the ceramic curing process, because the temperature is relatively low (less than 300° C.), sintering and grain growing processes do not occur, and the composite ceramic grains keep their original nanoscale structure, to form a hydrophobic coating similar to the “lotus effect”. In addition to preventing the carbon material from being oxidized and deteriorated during heating, the coating can further have anti-sticking and self-cleaning functions.

As shown in FIG. 4, the infrared heater further includes a conductive element, and the conductive element is configured to provide power of the battery cell 13 to the carbon material heating film 122.

In this example, the conductive element includes a first electrode 1241 and a second electrode 1242 spaced apart. The first electrode 1241 includes a conductive portion 12411 and a coupling portion 12412, and the second electrode 1242 includes a conductive portion 12421 and a coupling portion 12422. The conductive portion 12411 and the conductive portion 12421 are both arranged between the carbon material heating film 122 and the anti-oxidization layer 123, to come into contact with the carbon material heating film 122 to form an electrical connection. Moreover, because the conductive portion 12411 and the conductive portion 12421 are both covered by the anti-oxidization layer 123, the problem that it is easy for an oxidization reaction to occur in contact parts of the conductive portions and the carbon material heating film 122 because of an excessively high temperature may be avoided. The coupling portion 12412 and the coupling portion 12422 extend out of the anti-oxidization layer 123 from the conductive portion 12411 and the conductive portion 12421 respectively, and extending end portions may extend out of the support member 121 or be arranged on the support member 121. The coupling portion 12412 and the coupling portion 12422 are configured to be coupled to an anode and a cathode of the battery cell 13 respectively.

The first electrode 1241 and the second electrode 1242 may be arranged at a same end or different ends of the support member 121. The first electrode 1241 and the second electrode 1242 may be coatings or conductive metal sheets. The first electrode 1241 and the second electrode 1242 may be made of materials of metal or alloy with a low resistivity, such as silver, gold, palladium, platinum, copper, nickel, molybdenum, tungsten, niobium, or an alloy material of the foregoing metals. After receiving power provided by the first electrode 1241 and the second electrode 1242, the carbon material heating film 122 radiates infrared to the chamber 11, to heat the aerosol forming substrate received in the chamber 11.

Referring to FIG. 1 again, the infrared heater 12 may further include a heat insulation tube 15, and the heat insulation tube 15 is arranged on a periphery of the anti-oxidization layer 123. The heat insulation tube 15 may avoid a case that a large quantity of heat is transferred onto a shell of the aerosol generation device 10 to make a user feel hot. Further, an infrared reflection layer may be further formed on an inner surface of the heat insulation tube 15, and the infrared reflection layer may reflect the infrared radiated by the infrared heater 12 to the chamber 11, to improve infrared heating efficiency. The infrared emitting layer may be made of one or more of gold, silver, nickel, aluminum, gold alloy, silver alloy, nickel alloy, aluminum alloy, gold oxide, silver oxide, nickel oxide, aluminum oxide, titanium oxide, zinc oxide, and cerium dioxide.

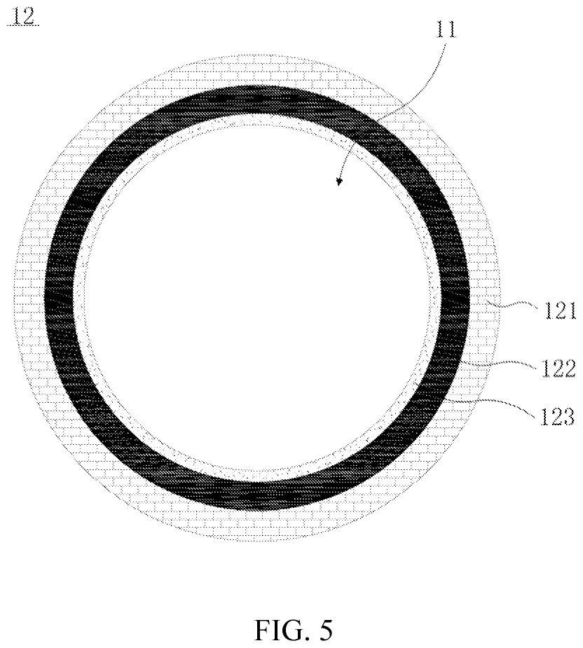

FIG. 5 shows another infrared heater 12 according to an implementation of this application. Different from FIG. 3 and FIG. 4, a carbon material heating film 122 is bound to an inner surface of a support member 121, and an anti-oxidization layer 123 is formed on an inner surface of the carbon material heating film 122.

In the example, the support member 121 may be made of a material such as flexible glass, PI (polyimide) film, or flexible ceramic paper, preferably PI film. The carbon material heating film 122 has specific rigidity, and may be wound together with the support member 121 to form a tube shape.

in another example, the support member 121 may alternatively be made of a high-temperature resistant and transparent material such as quartz glass, ceramic, or mica.

It should be noted that, the foregoing embodiment is described with only one infrared heater 12 as an example. In another example, the aerosol generation device 10 may include a first infrared heater and a second infrared heater, and the first infrared heater and the second infrared heater are constructed to independently start to implement segmented heating.

For structures of the first infrared heater and the second infrared heater, reference may be made to the foregoing content. Details are not described herein. The first infrared heater and the second infrared heater may be arranged in an axial direction of a chamber 11, to heat different parts in an axial direction of an aerosol forming substrate, and then implement segmented heating; and may alternatively be arranged in a circumferential direction of the chamber 11, to heat different parts in the circumferential direction of the aerosol forming substrate, and then implement segmented heating.

It should be noted that, this specification of this application and the accompanying drawings thereof illustrate preferred embodiments of this application. However, this application can be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or variations according to the above descriptions, and such improvements and variations shall all fall within the protection scope of the appended claims of this application.

1. An aerosol generation device, comprising a chamber configured to receive an aerosol forming substrate, at least one infrared heater, and a battery cell providing power to the infrared heater, wherein
the infrared heater comprises:
a carbon material heating film, configured to radiate infrared to the chamber, to heat the aerosol forming substrate received in the chamber;
a support member, configured to support the carbon material heating film;
a conductive element, configured to provide the power to the carbon material heating film; and
an anti-oxidization layer, formed on at least a part of a surface of the carbon material heating film and covering a part of the conductive element.

2. The aerosol generation device according to claim 1, wherein the anti-oxidization layer is formed on the surface of the carbon material heating film in at least one manner of brushing, dip coating, spraying, physical vapor deposition, and chemical vapor deposition.

3. The aerosol generation device according to claim 2, wherein the anti-oxidization layer is formed on the surface of the carbon material heating film in the dip coating manner, and a dip coating solution comprises at least one of silicon dioxide, aluminum oxide, magnesium oxide, calcium oxide, zinc oxide, titanium dioxide, tin oxide, lanthanum oxide, and bismuth oxide.

4. The aerosol generation device according to claim 2, wherein the anti-oxidization layer is formed on the surface of the carbon material heating film in the spraying manner, and a spraying solution comprises at least one of silicon dioxide, aluminum oxide, zirconium oxide, zinc oxide, titanium dioxide, cerium oxide, and lanthanum oxide.

5. The aerosol generation device according to claim 4, wherein the spraying solution further comprises at least one of a dispersing agent, a defoaming agent, and a bonding agent.

6. The aerosol generation device according to claim 1, wherein the anti-oxidization layer has a thickness ranging from 1 to 50 μm, preferably 1 to 40 μm, further preferably 1 to 30 μm, further preferably 2 to 30 μm, and further more preferably 3 to 30 μm.

7. The aerosol generation device according to claim 1, wherein the carbon material heating film is constructed to extend in an axial direction of the chamber and at least partially surround the chamber.

8. The aerosol generation device according to claim 1, wherein the carbon material heating film has a first surface and a second surface opposite to each other; and the first surface faces the chamber; and
the support member is bound to the first surface, and the anti-oxidization layer is formed on the second surface; or the anti-oxidization layer is formed on the first surface, and the support member is bound to the second surface.

9. The aerosol generation device according to claim 1, wherein the support member is constructed as a tube shape extending in an axial direction of the chamber and surrounding the chamber.

10. The aerosol generation device according to claim 1, wherein the conductive element comprises a conductive portion and a coupling portion; and
the conductive portion is arranged between the carbon material heating film and the anti-oxidization layer, and the coupling portion extends out of the anti-oxidization layer from the conductive portion.

11. The aerosol generation device according to claim 1, wherein the aerosol generation device comprises a first infrared heater and a second infrared heater, and the first infrared heater and the second infrared heater are constructed to independently start to implement segmented heating.

12. An infrared heater for an aerosol generation device, the aerosol generation device comprising a chamber configured to receive an aerosol forming substrate and a battery cell providing power to the infrared heater, wherein the infrared heater comprises:
a carbon material heating film, configured to radiate infrared to the chamber, to heat the aerosol forming substrate received in the chamber;
a support member, configured to support the carbon material heating film;
a conductive element, configured to provide the power to the carbon material heating film; and
an anti-oxidization layer, formed on at least a part of a surface of the carbon material heating film and covering a part of the conductive element.
